(19) United States
(12) Patent Application Publication
(10) Pub. No.: US 2022/0295843 A1
(43) Pub. Date: Sep. 22, 2022

(54) LOW ALLERGENICITY WELL COOKED FOOD POWDER

(71) Applicant: LIL MIXINS. LLC, PHILADELPHIA, PA (US)

(72) Inventors: MEENAL LELE, PHILADELPHIA, PA (US); JAMES PETITTI, EL SEGUNDO, CA (US)

(21) Appl. No.: 17/480,275

(22) Filed: Sep. 21, 2021

Related U.S. Application Data
(63) Continuation-in-part of application No. 17/202,901, filed on Mar. 16, 2021, now Pat. No. 11,154,081.

(51) Int. Cl. A23L 15/00; A23L 5/10; A23L 5/30; A23L 33/00; A23L 5/00

(52) U.S. Cl. CPC A23L 15/30; A23L 5/13; A23L 5/30; A23L 33/40; A23L 5/55

(57) ABSTRACT

A nutritional or dietary egg supplement or food product is provided that may be eaten by children or adults. The food product is made solely of whole hen's eggs or egg whites that have been heat treated to selectively denature allergenic proteins contained therein.

### CROSS-REFERENCE TO RELATED APPLICATION

This patent application is a continuation-in-part of non-provisional patent application Ser. No. 17/202,901, filed on Mar. 16, 2021, the disclosure of which is incorporated by reference herein in its entirety.

### BACKGROUND OF THE INVENTION

As is known, food allergy rates have been on the rise over the last several years. In particular, egg allergy is the second most common food allergy in infants and young children. Egg allergies are IgE antibody mediated immunologic responses to proteins in a hen's egg.

Studies and a subsequent meta-analysis have shown that starting regular exposure of eggs between the ages of 4 and 6 months old, and continuing that exposure through the 1st birthday can provide protection against egg allergy. The problem, however, is that babies cannot eat cooked eggs in their natural form at that young an age. They choke easily and typically require food in mush or slurry form.

A meta-analysis of the prevalence of food allergy estimates that egg allergy affects 0.5 to 2.5 percent of young children.

The form of the egg has been shown to be a contributing factor to egg allergy prevalence. An Australian population-based cohort study challenged children using raw egg white and reported an egg allergy prevalence of 9.5 percent (95% CI 8.7-10.3 percent) at one year and 1.2 percent (95% CI 0.9-1.6 percent) at four years. Challenge-proven egg allergy in South African toddlers (12 to 36 months) was 1.9 percent (95% CI 1.1-2.7) for raw egg white and 0.8 percent (95% CI 0.3-2.3) for cooked egg.

Five domestic chicken egg proteins (Gallus domesticus) have been identified as responsible for IgE-mediated reactions; these are designated Gal d 1 to 5. Most of the allergenic egg proteins are found in egg white, including ovomucoid (Gal d 1), ovalbumin (Gal d 2), ovotransferrin (Gal d 3), lysozyme (Gal d 4), and ovomucin.

Ovomucoid is the dominant allergen in egg (i.e., is the allergen to which the most patients are sensitized), although ovalbumin is the most abundant protein comprising hen's egg white.

Currently available in the marketplace is the product SpoonfulOne, which is a powder blend of small amounts of different food protein. These food proteins include peanuts, milk, raw eggs, almonds, soy, wheat, shrimp, cashews, hazelnuts, oat, cod, pecans, salmon, sesame, walnuts, and pistachios. Each daily serving has less than 1 gram total of 16 different proteins. SpoonfulOne is less than desirable since it does not provide a sufficient amount of protein as proven to reduce food allergy rates. The egg protein in SpoonfulOne is not a well-cooked egg.

Ready, Set, Food sells a powder in single serve packs which contains peanut, milk, and raw eggs. The egg protein in ReadySetFood is not a well-cooked egg. Grocery alternatives include eggs, which must be cooked and prepared for a baby. Scrambled eggs are problematic since they clump, thereby providing a choking risk for a baby. Scrambled eggs are not considered well-cooked, but rather heated or lightly cooked. Correct preparation is to boil the eggs, and then puree the egg into food. Also, raw egg powder may be used, which is either freeze-dried, spray dried, or drum dried raw egg. When mixed with water, egg powders turn into raw, uncooked egg which must then be prepared like a grocery egg. Studies have found that the majority of egg-allergic individuals can tolerate extensively heated (well-cooked) or baked egg.

Heating denatures proteins, reducing allergenicity of ovalbumin and ovomucoid and thereby altering digestion and absorption of these proteins in the gastrointestinal tract.

Ovalbumin epitopes are heat labile, but ovomucoid epitopes are not altered by extensive heating, suggesting that children who have specific IgE primarily to ovalbumin are likely to tolerate heated forms of egg.

Properly “well-cooked” eggs should reduce the allergenicity of the ovalbumin and ovomucoid by at least 20% up to 100%.

Well-cooked eggs have been studied in multiple studies and shown to reduce the risk of egg allergy when fed to infants regularly.

Per the 2020 AAAAI guidelines, and the 2020 USDA Dietary Feeding guidelines, all infants should be fed well-cooked egg in an infant safe form.

The need therefore exists for an infant safe well-cooked egg that meets these requirements. Accordingly, it would be desirable to provide a well-cooked egg food product that is specially created for babies in order to reduce the risk of developing a food allergy. The product should contain a suitable quantity of food protein, and should not be overly processed. Additionally, the well-cooked egg food product should have a minimal risk of choking and should have a markedly reduced chance of bacterial or fungal growth.

The need therefore exists for an infant safe well-cooked egg food product that can provide uniform and desired levels of total and allergenic egg proteins to infants.

### SUMMARY OF THE INVENTION

Generally speaking, in accordance with the invention, a nutritional or dietary supplement or food product is provided that may be eaten by children or adults. The food product is made solely of whole hen's eggs or egg whites that have been extensively heat treated to selectively denature the allergenic proteins relative to a natural hen's egg as measured by analytic techniques such as SDS-PAGE or ELISA.

Accordingly, it is an object of the invention to provide an improved egg food product for infants or babies.

Another object of the invention is to provide an egg food product that has a sufficient amount of food protein.

A further object of the invention is to provide an egg food product that is easy for an infant or baby to eat and digest.

Yet another object of the invention to create an improved egg food product with a texture that is developmentally appropriate for an infant as young as 4 months old.

Still a further object of the invention is to provide a hen's egg food product that has reduced Gal d 2 (ovalbumin) without the use of other ingredients, enzymes, or preservatives.

Another object of the invention is for an egg food product that is shelf-stable at room temperature for at least 6 months.

A further object of the invention is an egg food product that is water soluble.

Still other objects and advantages will be obvious from the following description.

### DETAILED DESCRIPTION

The inventive process begins with selecting either whole eggs in shells or liquid egg whites or liquid whole eggs. The liquid eggs (whites or whole) if selected, may be raw or frozen. Frozen liquid eggs, if selected for the inventive process, are typically first defrosted.

The next step in the inventive process includes heating the whole eggs or egg liquid (whites or whole) in order to denature at least 20% and up to 100% of their ovalbumin proteins (gal d 2), as well as to denature at least 20% and up to 100% of their ovomucoid proteins (gal d 1). In other words, due to the heating process, the whole eggs or liquid eggs will then contain from about 0% to about 80% of their initial allergenic ovalbumin protein amount, and from about 0% to about 80% of their initial allergenic ovomucoid protein amount.

The heating step may be carried out by boiling the whole eggs or egg liquid at 100 C for at least 10 minutes, and up to 30 minutes. The purpose is to denature the proteins in the eggs, as described herein. The exact time will depend on the desired level of protein to be denatured, the longer the eggs are boiled, the more the protein in the eggs will be denatured. The whole egg in its shell or liquid egg white or liquid whole egg may, alternatively, be baked using dry heat at approximately 170 C-185 C for from about 10 minutes, and up to about 30 minutes. The eggs must be cooled after either boiling or baking; in the case of whole eggs, the shells are removed. The next step in the process is that the well-cooked eggs and water are aggressively mixed utilizing a suitable high shear mixer or blender or agitator until the mixture is homogenous with from 5%-25% solids by weight. The shelled cooked eggs may first be chopped or diced prior to being added to the high shear mixer.

Mixing should be carried out without the addition of heat or some other pasteurization step that would otherwise affect the proteins in the eggs. The resulting mixed egg solution should be homogenous, meaning that it can pass through at least a 16 mesh screen (U.S. Standard mesh size), and have a viscosity in the range of 100-1000 cp. The next step in the process is drying the mixture in order to produce a dried egg powder product. The mixture must be continuously agitated prior to drying to maintain homogeneity. The drying process must be kept aseptic at all times by using sanitizing equipment, and good manufacturing procedures.

Drying may be performed using a spray dryer that is operated at a preferred pressure, with an inlet temp of about 160 C-220 C, and outlet temperature of about 60 C-90 C. Spray drying pushes the liquid through a nozzle, which has holes that determine the size of the particles that exit therefrom. The resulting dried egg powder should have a particle size of between about 60 and 200 mesh (U.S. standard).

Alternatively, drying may be carried out using a drum drier, dehydrator, or freeze-dryer; however drying by means of a drum dryer, dehydrator or freeze-dryer will require the use of a milling or grinding step after drying to achieve a dried egg powder having a particle size of between about 60 and 200 mesh.

The dried egg powder should be at least 90% water soluble as measured through a 20 mesh screen (no more than 10% of the particles are caught in the screen). In use, the well-cooked egg powder product of the invention is proportioned and fed to infants older than 4 months old by mixing the powder into breastmilk, formula, or developmentally-appropriate pureed foods. Suitable pureed foods include vegetables, fruits, yogurt, or wheat cereal. The well-cooked egg powder product of the invention is preferably fed to infants 1-3 times per week in serving sizes of about 0.5 g to about 2 g of egg protein so as to provide an adequate exposure to eggs that is necessary to reduce the risk of developing allergic sensitization to eggs. The well-cooked egg powder product may be analyzed in a laboratory to determine its protein content per gram of powder product. The protein content amount of the powder may be indicated in the packaging that is utilized to store, contain, sell, etc., the well-cooked egg powder product such that a consumer can manually determine how much powder product to utilize based on the desired or preferred protein content per serving.

The well-cooked egg powder product produced in accordance with the invention is advantageous in that the correct amount of proteins per serving is provided in feeding to an infant. This is because the powder is uniform in nature and the protein content per gram is determined by protein analysis. By way of example, if a parent were to prepare eggs and feed them to a baby, the protein in the eggs is not uniformly present. Producing an egg powder in accordance with the invention provides for uniformity across servings.

The powdered egg product produced in accordance with the invention is advantageous since it has good water absorption and water adhesion characteristics. This is because it is dried and can absorb water. As a result, the powder is easily mixed into pureed food. The powdered egg product produced in accordance with the invention is advantageous since the individual granules thereof do not adhere to each other. This is because the heating and drying process creates a stable granule. As a result, the powder cannot form a gel or solid when mixed with water. This property prevents the risk of choking an infant. The powdered egg product produced in accordance with the invention is advantageous as it is specifically designed as an infant food product. This is because it is easily mixed into any age appropriate food and will not increase the risk of choking. As a result, it is appropriate to be fed to an infant who can tolerate solid food.

Optionally, the powdered egg product produced in accordance with the inventive steps described above may be heated to denature at least some of the allergenic ovalbumin and ovomucoid proteins that may still be present in it. The heating step may include, for example, placing the well-cooked egg powder product in a chamber heated to a temperature of between about 212 F to about 400 F for a time period ranging from about 3 minutes to about 30 minutes.

The egg powder material may be continuously or periodically stirred while being heated to ensure uniform heating of the powder.

The optional heating step may also be referred to as a “second” heating step or a “powder” heating step since the food product being heated is in powder form. The powder heating step will denature Gal d 1 that was less affected by the first heating step, allowing one to further denature Gal d 1 from about 50% to about 100% of the Gal d 1 protein contained in raw eggs before the first heating step, and achieve a food product with a desired level of both allergenic proteins (e.g., both the Gal d 1 and Gal d 2 proteins).

This is so because the powder heating step is being performed on dry egg powder material, as opposed to the first heating step which was being performed on liquid egg material. Therefore, the dry heating step (or second heating step) ensures that the dry heated, well-cooked egg powder material will have a significantly reduced level of allergenic ovalbumin and ovomucoid proteins, if any at all.

The powder heating step will not change the particle size of the granules that make up the powdered egg product. The powder heating step may reduce the water content of the powdered egg product, and may also reduce the water solubility of the powdered egg product such that the product is 70% to about 90% water soluble as measured through a 20 mesh screen.

The scope of the invention will now be set forth in the following claims.

1. A method of producing an infant or baby food product comprising:
heating whole eggs or egg whites by baking the whole eggs or egg whites a temperature of between about 170 C and 185 C for between about 10 and 30 minutes or boiling the whole eggs or egg whites for between about 10 and 30 minutes in order to denature at least 20% and up to 100% of the amount of at least one allergenic protein contained therein;
allowing the heated whole eggs or egg whites to cool;
mixing the cooled whole eggs or egg whites with water in order to produce a homogenous mixed egg solution;
drying the homogenous mixed egg solution in order to produce a dried egg powder product; and
heating the dried egg powder product at a temperature of between about 212 F and 400 F for a time period ranging from about 3 minutes to about 30 minutes in order to create the infant or baby food product.

2-4. (canceled)

5. The method of claim 1, wherein the at least one allergenic protein that is denatured in the step of heating whole eggs or egg whites is selected from the group consisting of ovalbumin (Gal d 2) and ovomucoid (Gal d 1).

6-8. (canceled)

9. The method of claim 1, wherein the mixing step produces a mixed egg solution that is between about 5% and 25% solid by weight.

10. The method of claim 1, further including the step of chopping or dicing the whole eggs or egg whites eggs prior to the mixing step.

11. The method of claim 1, wherein the mixing step is carried out without the addition of heat or other pasteurization process.

12. The method of claim 1, wherein the mixing step produces a homogeneous mixture that can pass through at least a 16 mesh screen and has a resulting viscosity between about 100 and 1000 cp.

13. The method of claim 1, wherein the drying step is carried out by using a spray dryer with an inlet temperature of between about 160 and 220 C and outlet temperature of between about 60 and 90 C.

14. The method of claim 13, wherein the dried egg powder product that is produced following the drying step has a particle size that is between about 60 and 200 mesh.

15. The method of claim 1, further including the step of milling or grinding the dried egg powder product that is produced following the drying step.

16. The method of claim 15, wherein the dried egg powder product that is produced following the milling or grinding step has a particle size that is between about 60 mesh and 200 mesh.

17. The method of claim 1, wherein the dried egg powder product that is produced following the drying step is capable of passing through a 20 mesh screen, and the dried egg powder product that is produced following said drying step is at least 90% water soluble.

18. The dried egg powder product produced by the method of claim 1.

19. The dried egg powder product produced by the method of claim 6.

20. A method for reducing the risk of developing a food allergy to eggs, the method comprising preparing a dried egg powder product in accordance with the steps of claim 1 and feeding said food product to a baby or infant of an age of at least four months old.

21. The method of claim 20, further including mixing the dried egg powder product into a food selected from the group consisting of breastmilk, formula and a pureed food prior to the feeding step.

22. The method of claim 20, wherein the feeding step is carried out in pre-measured servings of the dried egg powder product at a frequency of 1-3 times per week, each pre-measured serving containing from about 0.5 g to about 2 g of egg protein.

23. The method of claim 20, wherein the preparing step includes:
heating whole eggs or egg whites by either boiling or baking in order to denature from about 25% to about 100% of the amount of at least one allergenic protein contained therein;
mixing the cooled whole eggs or egg whites with water in order to produce a mixed egg solution that is between about 5% and 25% solid by weight; and
drying the mixed egg solution in order to produce a dried egg powder product which has a particle size of between about 60 mesh and 200 mesh and a water solubility of at least 90% through a 20 mesh screen.

24. The method of claim 1, wherein the step of heating the dried egg powder product is carried out at a temperature of between about 212 F and 271 F for a time period ranging from about 3 minutes to about 19 minutes.
